(19) United States
(12) Patent Application Publication
(10) Pub. No.: US 2026/0212487 A1
(43) Pub. Date: Jul. 23, 2026

(54) DEFECT MAPPING AND REPAIR SYSTEMS AND METHODS

(71) Applicants: Inovision Software Solutions, Inc., Chesterfield, MI (US); 3M Innovative Properties Company, St. Paul, MN (US)

(72) Inventors: Jonathan Bement Arthur, St. Paul, MN (US); Jordan Craig, St. Paul, MN (US); Thomas J Strey, St. Paul, MN (US); Jacob Allen, Chesterfield, MI (US); Andrew Gary Gagne, Chesterfield, MI (US)

(21) Appl. No.: 18/857,566

(22) PCT Filed: Apr. 19, 2023
(86) PCT No.: PCT/US2023/019131

§ 371 Date: Oct. 17, 2024

Related U.S. Application Data
(60) Provisional application No. 63/363,272, filed on Apr. 20, 2022.

(51) Int. Cl. G06T 7/00; G06T 1/00; G06T 7/70

(52) U.S. Cl. CPC G06T 7/001; G06T 1/0014; G06T 7/70; G06T 2207/30156

(57) ABSTRACT

A system (100) for identifying and repairing one or more defects on a surface of an object (102). The system can have a robotic paint repair apparatus (110) with a robotic arm (114) and a tool (120, 122) mounted to the robotic arm. The tool can remove the one or more defects. The system can have a camera (124) can be positioned adjacent the robotic paint repair apparatus within a repair area. The camera configured to scan a portion of the surface of the object having at least one of the one or more defects and collect scan data. The system can have a controller configured to control the camera to scan the area of the surface based upon a first data representing a location of the one or more defects on the surface of the object gathered at a location that differs from the repair area.

### PRIORITY CLAIM

This application claims the benefit of priority to U.S. Provisional Patent Application No. 63/363,272, filed on Apr. 20, 2022, the contents of which are incorporated herein by reference.

### TECHNICAL FIELD

This disclosure relates to an object inspection system and to a method for inspecting an object and, more particularly, to an object inspection and repair system and method which identifies defects at a location where robotically implemented repairs using a surface modification tool(s) is performed.

### BACKGROUND

The automotive industry often needs to prepare surfaces of vehicle parts or replacement parts (e.g., a bumper) for various purposes (e.g., painting), or to repair surfaces of car parts or replacement parts due to defects incurred during painting or coating. Typical surface preparation and repair processes include, for example, physical surface modification of vehicle surfaces such as sanding and polishing. Surface preparation and repair of defects on surfaces can utilize different tools, materials and fluids.

In the automotive industry (e.g., automotive original equipment manufacturing (OEM) and aftermarket sectors), clear coat repair of a specular surface has not been automated. Techniques are desired for automating this process as well as other paint applications (e.g., primer sanding, clear coat defect removal, clear coat polishing, etc.) amenable to the use of abrasives and/or robotic inspection and repair.

On the object detection side, historically manufactured objects were typically visually inspected by personnel in order to detect flaws, imperfections, or other unwanted features on their respective surfaces. Visual inspects by personnel are costly (e.g., requiring personnel to be paid to visually inspect the produced objects), may result in worker fatigue from repeated manual inspection and repair, and are less reliable since the detection rate is based upon the various dissimilar visual abilities of the inspectors. To address these issues, electronic systems have been implemented which utilize cameras, lights, and computers to capture images objects and perform analysis using the images to detect defects including unwanted surface features. However, these systems perform inspection prior to and at a different location from a repair location. From the point of defects being identified on the vehicle by the system error is introduced in the ascertained position of those defects due to movement of the vehicle on a carriage, rail or assembly line structure as well as from vibration and interaction with the repair tool. This error can result in larger than desired areas of the vehicle surface being repaired. These larger than desired areas can result in higher costs, slower repair times and other drawbacks as further discussed herein.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

This disclosure describes systems, apparatuses, methods and techniques related to various problems in identifying positional error and automating defect-specific repairs such as for paint or other applications. Current processes of having humans manually inspect and/or repair a workpiece are time consuming. As discussed above, electronic implemented defect identification systems have drawbacks in that positional errors can be introduced from the time the position of the defect is ascertained until the defect is repaired. The present inventors have invented systems, apparatuses, methods and techniques that allow for automated defect identification on a surface of an object and more accurate automated repair of the defect on the surface of the object. Furthermore, the present inventors recognize that scanning at the point of repair can collect data that can be utilized for other purposes such as to improve the accuracy of the automated defect identification system (e.g. improving understanding of the defect position and/or improving understanding of one or more characteristics of the defect such as defect type, shape or even lack of defect (false positive)). Additionally, the present inventors recognize that scanning at the point of repair can collect data regarding one defect (such as position) that can be extrapolated globally to other defects on the object. This can reduce the need for scanning at the point of repair of every individual defect on the object. Rather, coordinates of the various defects gathered during the initial scan of the object can be redetermined at the point of repair, and repair can be performed using this more accurate data. In addition, the various systems, apparatuses, methods and techniques can reduce repair time, reduce tool wear and other waste, improve aesthetics and improve line throughput. Thus, various benefits recognized and unrecognized may be achieved.

The details of one or more examples of the disclosure are set forth in the accompanying drawings and the description below. Other features, objects, and advantages of the disclosure will be apparent from the description, drawings, and claims.

### BRIEF DESCRIPTION OF DRAWINGS

FIG. 1 is a schematic diagram illustrating an assembly line with a painted vehicle, defect scanning system and robotic repair apparatus in accordance with one example of the present application.

FIG. 1A is an enlarged view of an end effector portion of the robotic repair apparatus showing one or more tools and a camera in accordance with one example of the present application.

FIG. 2 is a schematic diagram of a system that includes a controller, a robotic repair system having visual inspection capability and an initial inspection system in accordance with one example of the present application.

FIG. 3 is a perspective view of a tracked object in combination with a conveyor assembly of the assembly line of FIG. 1 and further illustrating a utilized world coordinate system in accordance with one example of the present application.

FIG. 4 is a schematic diagram illustrating an example system for robotic paint repair using a paint repair robot that manipulates a one or more surface modification tools and a second robot with a camera in accordance with one example of the present application.

FIGS. 5A-5B are schematic diagrams of a method whereby positional error in locating a defect is introduced through motion of an object the defect is on from a first location to a second location and a surface modification in a repair area to address the defect, FIG. 5C further illustrates the repair area is reduced using systems, apparatuses, methods and techniques in accordance with one example of the present application.

FIG. 5D illustrates the positioning of the defect may be used to globally realign positioning of other defects in accordance with one example of the present application

FIGS. 6A-6C are schematic diagrams of a method whereby another positional error in locating a second defect is introduced through vibration of an object the second defect and the vibration dynamics are analyzed to better address the repair of the defect using systems, apparatuses, methods and techniques in accordance with one example of the present application.

FIG. 7 is a schematic diagram of a robotic repair system including portions of defect repair robots at least one with a camera, wherein at least one of the defect repair robots scan a portion of a vehicle chassis while others of the defect repair robots manipulate a sanding tool and a polishing tool, in accordance with an example of the present application.

FIG. 8 is a flow diagram of a method of performing automated defect identification and automated defect repair on an object, in accordance with one example of the present application.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides an automated system and methods of using defect inspection for robotic implemented repair with an end-of-arm system having mounted tools for surface modification of an object surface. The automated systems and methods also allow for end-of-arm defect identification with one or more cameras. As an example, one or more cameras can be mounted substantially perpendicular, be offset from, or arranged in another manner with respect to one or more of the tools that perform the surface modification. The use of one or more cameras for defect inspection at the location of repair provides various benefits previously discussed including reduced processing time, as the size of areas covered by repair can be reduced. The present application also recognizes other benefits such as improved aesthetics, reduced waste, reduced tool wear and collection of data that can be utilized for improvement of data analytics or the like. Moreover, in some circumstances, damage to the vehicle or the end-of-arm system may be avoided by using information gathered by the system to avoid repairs the system is not suited to make (e.g., locations where the tool may inadvertently impact a nearby vehicle surface, or locations where no defect actually exists).

The one or more cameras can be mounted on an end effector at the end of a motive robot arm (with or without an associated tool assembly), such that they capable of moving relative to the object (e.g. approaching a portion to zoom and increase resolution). The surface modification tool may include a functional component configured to contact and prepare the object surface and one or more sensors and/or actuators configured to detect working state information of the end-effector tool and/or alter its working state. Various sensors and/or actuators can include force sensor(s), force-torque sensor(s), force control unit(s), etc.

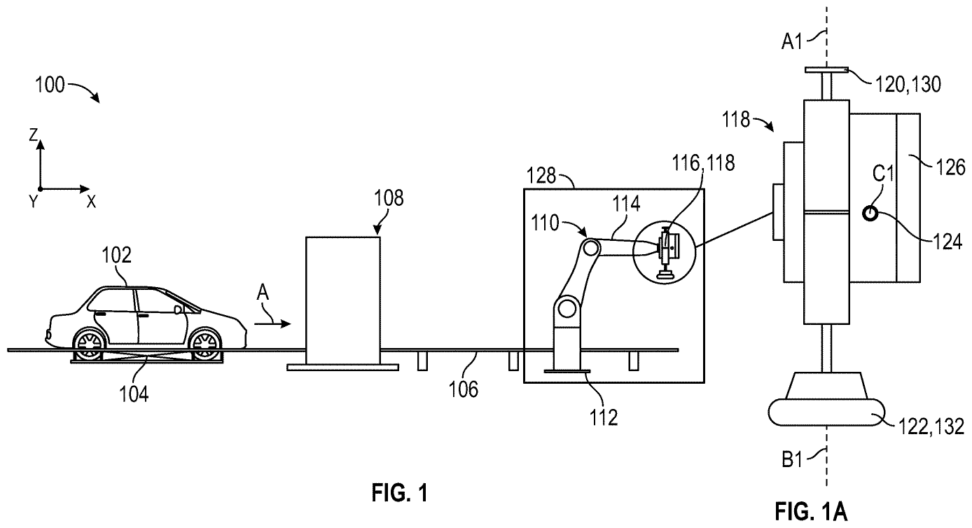

It should be understood that although illustrative implementations of one or more embodiments are provided below, the disclosed systems and/or methods described with respect to FIGS. 1-8 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents. The term “vehicle” as used herein is not limited to a car but includes an automobile, a truck, a boat, an airplane, helicopter, bus, or other means of transportation. The term “defect” as used herein refers to an unwanted feature such a blemish or unwanted surface condition. This term “defect” can include, but is not limited to, a hair or other fiber, dust or other particulate within/upon a painted surface, an area missing coating such as a scratch, dent or other type of depression upon a painted surface, and a projection, bump or raised portion of a painted surface, and/or an area of undesirable color such as a different color, in which the paint has not been properly applied or properly cured. Examples of defects include micropops-tiny sub mm sized areas where solvent pop breaks through clear coat; orange peel-uneven layers of paint; mars-areas where vehicle was touched; shallow paint, or the like. The terms “board”, “processor” “processing assembly”, and “server” (as well as other utilized descriptive names) may be used interchangeably and these terms are meant to generally refer to some sort of processor based entity without limiting the referred to entity to any particular hardware or software configuration. As used herein the term “fluid” means any one or combination of a pure fluid, a fluid in combination with particulate such as a slurry, debris from surface modification or any of the like. The term “surface modification” or the like includes repair of a surface, abrading, scuffing, sanding, polishing, buffing or the like. The term “substantially” means up to but not exceeding 15%, inclusive, from the amount or value provided (e.g., between exactly the amount of value and 15 degrees from exactly parallel, inclusive). The term “surface” is not limited to a specular surface but can include matte, metal or other type finishes. The term “surface” need not be a painted surface in all cases.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples.

The software may be executed on a digital signal processor, ASIC, microprocessor, or other type of processor operating on a computer system, such as a personal computer, server or other computer system, turning such computer system into a specifically programmed machine.

FIG. 1 is a schematic illustrating an assembly line system 100 with a painted vehicle 102, a carriage 104, a rail system 106, a defect identification system 108 and a robotic repair apparatus 110. The robotic repair apparatus 110 can have a base 112, an arm 114, an end effector 116 and an assembly 118. As shown in FIG. 1A the assembly 118 can include a first tool 120, a second tool 122, one or more cameras 124 and a light 126.

FIG. 1 illustrates the painted vehicle 102 mounted to the carriage 104 in a known manner. The carriage 104 can be coupled to the rail system 106 to transport the painted vehicle along the assembly line system 100 as shown by arrow A. Although a vehicle body or chassis is shown in FIG. 1, it is recognized with the present disclosure the systems, processes, techniques and apparatus can be utilized with any object (e.g., bumpers, hub caps) and is not limited to the automotive field. Furthermore, although FIG. 1 depicts the assembly line system 100 as a continuous process, it is understood that the systems, processes, techniques and apparatus can be utilized with a non-continuous process such as where a portion of assembly is performed in one location, fabrication is then halted and the vehicle 102 is then moved to another location (such as another facility) and other portions of the assembly are performed at the other location. The rail system 106 is purely exemplary and can include various types of transportation mechanisms. The rail system need not be continuously moveable but can be a stop station, diversion station or other type configuration as known in the art. Carriage 104 may not be coupled to a rail system 106 in some embodiments.

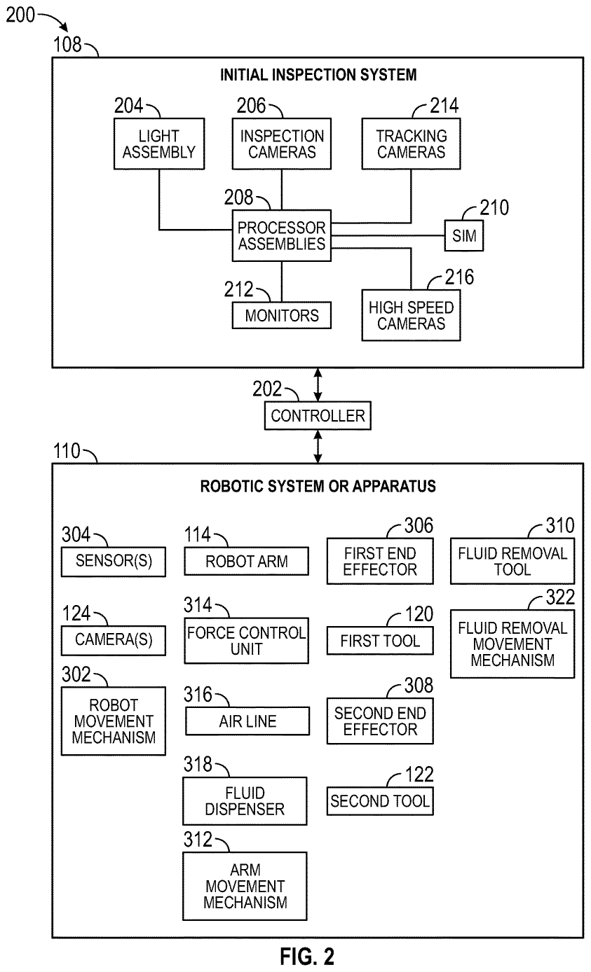

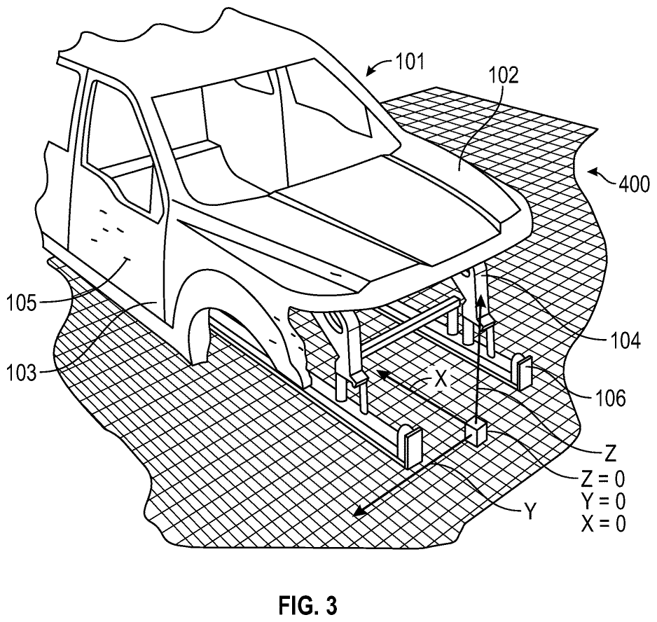

After baking to cure the paint, the painted vehicle 102 (sometime referred to as a chassis, a body or simply an object herein) mounted to the carriage 104 can enter the defect identification system 108. The defect identification system 108 can perform a global scan of all visible external facing surfaces of the painted vehicle 102 that may have defects according to some examples. However, a partial scan on only some surfaces may be performed according to further examples. Aspects of the defect identification system 108 are discussed in further detail in reference to FIGS. 2 and 3 of the disclosure. The defect identification system 108 can be constructed and operate in one or more of the manners described in U.S. patent application Ser. No. 15/932,865, which was filed on May 9, 2018 and U.S. patent application Ser. No. 16/866,110, which was filed on May 4, 2020, the entire disclosures of each of which are incorporated herein by reference.

The painted vehicle 102 can pass from the defect identification system 108 along the rail system 106 to a defect repair location 128 (sometimes also called a defect repair area or a second location herein). Robotic repair of the defect(s) on the painted vehicle 102 can be performed at the defect repair location 128 by the robotic repair apparatus 110, which is located within the defect repair location 128.

The base 112 can be coupled to the arm 114 of the robotic repair apparatus 110.

As shown in FIG. 1, the robotic arm 114 can be capable of movement in any of six dimensions relative to the base 112, with the capability to perform translations or rotations about an x-axis, y-axis and/or z-axis. The robotic repair apparatus 110 can have a force control unit (discussed subsequently) and the end effector 116 with the assembly 118 mounted thereto.

Referring now to FIG. 1A, the first and second tools 120, 122 can be configured to selectively interact with a surface such as a surface of the painted vehicle 102. The first tool 120 can be a backup pad configured to hold an abrasive for sanding, grinding or the like, in one embodiment, or another suitable abrasive tool. During an abrasive operation, the first tool 120 via an abrasive disc 130, or other suitable abrasive article, can abrade a surface of the painted vehicle 102 to remove material. The first tool 120 can be attached to the assembly 118 using adhesive, hook and loop, clip system, vacuum or other suitable attachment system. Similarly, the second tool 122 can be a second abrasive tool such as an abrasive pad 132 configured for polishing or buffing the surface of the painted vehicle 102. However, according to further examples the second tool 122 can have other configurations as known in the art such as a wiping medium, finer grain sanding implement, fluid removal tool (vacuum or air knife), etc. The second tool 122 can be attached to the assembly 118 using adhesive, hook and loop, clip system, vacuum or other suitable attachment system.

The assembly 118 can be configured such that that the first tool 120 and the second tool 122 share substantially parallel (and indeed substantially aligned) actuation axes Al and B1, respectively. Put another way, the first tool 120 can have a first axis A1 about which the first tool 120 is configured to rotate to perform surface modification of the workpiece. The second tool 122 can have a second axis B1 about which the second tool 122 is configured to rotate. The first axis A1 and the second axis B1 can be substantially aligned along the z-axis direction in the coordinate framework shown in FIG. 1. However, the first tool 120 can be on an opposing side of the assembly 118 from the second tool 122. The first tool 120 and second tool 122 can be any of or combination of linear, rotary, orbital or random orbital devices.

During the paint or clearcoat repair process, fluid may be dispensed on the workpiece prior to, during, or subsequent to the utilization of either of the first or second tools 120, 122. This process fluid may combine with particulate matter from the process to create a slurry. The particulate matter composing this slurry is generally caused by the sanding process, which usually takes place prior to a polishing or buffing step (using the second tool 122, for example). One or more wiping tools or implements (not shown) may be employed to remove the slurry and/or excess liquid as desired.

The one or more cameras 124 can be mounted to the assembly 118 adjacent the first tool 120 and the second tool 122. The one or more cameras 124 can have an axis C1 (passing through center of the lens(es)) that can be arranged substantially perpendicular to the first axis A1 and second axis B1. However, one or more mirrors can be employed such that the one or more cameras 124 can be arranged in any manner desired relative to the first tool 120 and the second tool 122. It can be desirable to mount the one or more cameras 124 on the assembly 118 close to a center of gravity of the assembly 118 as this can reduce likelihood of obstruction and/or unwanted vibration of the one or more cameras 124. The assembly 118 can be pivoted as desired to bring one of the first tool 120, the second tool 122 or one or more cameras 124 into an interfacing relationship with the surface of the painted vehicle 102. In regards to the one or more cameras 124, the one or more cameras 124 can be positioned by the robotic repair apparatus 110 as desired to scan the surface of the painted vehicle 102 in a desired area as further discussed.

The one or more cameras 124 can be a high resolution (e.g. greater than 12 MP) digital camera, for example. The one or more cameras 124 can have a zoom lens, according to some examples. However, a zoom lens is not required in all examples as the robotic repair apparatus 110 can move the position of the one or more cameras 124 as desired according to some examples. Thus, the robotic repair apparatus 110 can move the one or more cameras 124 toward or away from the surface of the painted vehicle 102 as desired. According to one example, the one or more cameras 124 can be configured to focus on an area about 150 mm by 150 mm at approximately 1 m distance. However, other area sizes and distances are contemplated and the area and distance provided above are provided for exemplary purposes. With defects for the painted vehicle 102 typically being smaller than 1 mm² various criteria such as resolution, zoom capability, distance, area, etc. can be manipulated as desired to achieve desired outcome of identifying the presence of the defect(s) on the surface of the painted vehicle 102 using the one or more cameras 124.

The light 126 can be mounted to the assembly 118 adjacent the one or more cameras 124. The light 126 can be a generic white light according to some examples.

However, characteristics of the light 126 such as size, color, position relative to the one or more cameras 124, etc. can be modified as desired as discussed in U.S. patent application Ser. Nos. 15/932,865 and 16/866,110.

The arrangement of the one or more cameras 124 and the light 126 is purely exemplary in FIG. 1A. Other arrangements and positioning relative to the first tool 120 and/or second tool 122 is also contemplated. For example, it is also contemplated that the one or more cameras 124 and/or light 126 can be mounted to a gantry system or other feature that is coupled to the robotic repair apparatus 110. Thus, the assembly 118 and/or end effector 116 could be bypassed and need not be coupled to carry the one or more cameras 124 and/or light 126 in some arrangements. In such arrangements, the gantry system or other feature may still be manipulated to move with movement of the arm 114, however.

Via mounting to the assembly 118, end effector 116, force control unit (discussed subsequently) and the arm 114, the first and second tools 120, 122 and the one or more cameras 124 have the ability to be positioned within the provided degrees of freedom by the robotic repair apparatus 110 (6 degrees of freedom in most cases) and any other degrees of freedom (e.g., a compliant force control unit) with its reference frame. This arrangement can allow for positioning of the first and second tools 120, 122 and the one or more cameras 124 as desired to perform repair and imaging. The one or more cameras 124 and light 126 can also be manipulated to be swept over the surface of the painted vehicle 102 to gather images from multiple positions as known in defect identification systems such as U.S. patent application Ser. Nos. 15/932,865 and 16/866,110.

FIG. 2 shows a schematic diagram of a system 200 that includes a controller 202, the defect identification system 108 and the robotic repair apparatus 110 according to one example. The controller 202 can electronically communicate with the defect identification system 108 and the robotic repair apparatus 110.

The defect identification system 108 can be configured to detect the presence of one or more defects upon the surface of an object such as the painted vehicle 102 (FIG. 1) as previously discussed. As shown in FIG. 2, the defect identification system 108 can include a first plurality of lights 204 which are placed along the pathway or direction in which the carrier of FIG. 1 (and the conveyor of FIG. 1) transports the produced object.

Each of the first plurality of lights 204 can each configured to respectively become selectively activated or energized and to thereafter selectively and controllably emit light energy. In one non-limiting example, the first plurality of lights 204 each comprise a light emitting diode type light, although other types of lights may be utilized. The first plurality of lights 204 can be distributed about the conveyor or movement assembly effective to produce a substantially uniform amount of light about and upon the object as the object moves along the path or direction. The first plurality of lights 204 can be arranged to produce a substantially uniform amount of intensity along this path or direction and on and about the object as it is moving.

The defect identification system 108 can further include a plurality of inspection cameras 206 which are also placed along the pathway or direction in which the carrier transports the object 14. The plurality of inspection cameras 206 can be to cooperatively receive reflected light energy being reflected from the surface of the object. Each of the plurality of inspection cameras 206 can be selectively energized and selectively activated once energized.

The reflected light energy gathered by the plurality of inspection cameras 206 includes first data or image data (image information) about the characteristics (e.g., visual characteristics) of the surface. This first data can be used to detect defects upon the surface of the object and for the other purposes discussed herein including in directing the one or more cameras 206 (FIG. 1A) to scan particular portions of the surface of the object. The defect identification system 108 with the plurality of inspection cameras 206 and lights 204 can be arranged to capture first data regarding substantially an entirety of the visible surfaces of the object (the exterior surfaces of the vehicle, for example).

The defect identification system 108 can have a dedicated processing assembly 208, which may comprise several distinct computer processors acting under stored program control, or a single computer processor assembly. According to further examples, the processing assembly 208 could be a component of the controller 202.

The processing assembly 208 can have numerous features or components not specifically shown. These can include an image tracking server or processor, post processing server or processor, a “NAS” or archive server or processor, a trigger board, and an encoder, for example. The processing assembly can further include a simulator 210.

The encoder can be communicatively coupled to the tracking server. In a non-limiting embodiment, the encoder can comprise a commercially available friction wheel encoder, which is manufactured and sold by Edon Controls, Inc. of Troy, Michigan. Other types of positional encoders may be utilized. The encoder can be movably coupled upon and to the conveyor or movement assembly and frictionally engages the carrier and turns (e.g., rotates) as the carrier moves along the conveyor or movement assembly. Such turning can provide continual information to the processing assembly 208 concerning the location of the carrier, and hence, the object along the path or direction. The simulator 210 can comprise a commercially available MATLAB® simulator with Simulink Math Works® tools. The simulator 210 can be a separate and distinct processing system from the processing assembly 208. The simulator 210 can be communicatively coupled to computer systems and monitors remote from the processing assembly 208 in some examples. Thus, the simulator 210 can be communicatively coupled to the controller 202 in a direct manner in some examples.

Tracking can also be achieved using a camera based vision tracking system and/or can be accomplished using 3D cameras rather than the encoder. In the case of a camera based vision system, there is a vision tracking server sending position data to the trigger board.

The processing assembly 208 can be electronically coupled to an output monitor and/or display assembly 212. The output monitor and/or display assembly 212 can include or be part of a display computer portion, operating under stored program control. The output monitor and/or display assembly 212 can include multiple display computer portions. The processing assembly 208 can be electronically coupled to each of the first plurality of cameras 206, one or more tracking cameras 214, and one or more high speed cameras 216.

The image processing server or processor can be communicatively coupled to the image capture server or processor. The post processing server or processor can be communicatively coupled to the image processing server or processor. The post processing server or processor can be communicatively coupled to the “NAS” or archive server or processor. The trigger board, image server, image processing server, post processing server, NAS, display computer portion, and tracking server can each connected to a communications network (such as, by way of example and without limitation, an Ethernet® network) through a switch and hence are in selective communication with each other through the network. The first plurality of lights 204 may also connected to the network. The plurality of cameras 206 and the plurality of lights 204 are each respectively and selectively “energizable” or “activatable” upon the receipt of commands from the triggering board or server.

Services such as windows service (e.g., stand-alone program) are also contemplated. Example services are: PLC service-communicate with PLC to get plant data about vehicle; tracking service-communicate with trigger board and other services to coordinate scanning process; image capture service-acquires images from the camera, image processing or GPU service-performs image processing steps to find defect regions of interest in the captured frames; classification service-neural network classifies the regions found; cluster service-locates found regions on 3D surface and clusters multiple images of same defect together on the surface, sizes defect, makes final determination about defect type, then creates images and data about the found defect.

The services also include a reporting service and an overhead display service (for displaying images on the output monitor). The services are distributed on the servers in various configurations.

The trigger board can be loaded with a table to map the vehicle positions where the cameras and lights will be triggered during a scan. The trigger board can input vehicle position from the encoder (or vision tracking system) and then triggers the cameras and lights at the specified locations. The trigger board can also have inputs from/to photo-eyes that are used to resyncroinize to predefined tracking synchronization locations when the vehicle breaks the photoeye. The trigger board can utilize positional information from the encoder to determine the identity and sequence of lights from the first plurality of lights 204 to illuminate and the identity and sequence of the first plurality of cameras 206 to activate. In essence, raw image is captured of and along the surface of the object as it is moved along the direction or path. The raw captured image data can be communicated to the processing assembly 208 (such as to an image capture server). The raw capture image data can then communicated to other components such as the image processing server, the controller 202, etc. for analyzation.

It is also contemplated that the controller 202 and/or the processing assembly 208 (such as via the image processing server and/or post processing server) can perform a selected sequence of image processing algorithms which are cooperatively effective to create first data (sometimes called first scan data herein) that comprises information such as a processed image of each of the raw captured image data (from raw images received). The processed images (first data or first scan data) can contain one or more regions of interest on the surface or can comprise a global entirety of the visible surfaces. The first data can additionally include information relating to one or more defects. Analysis can be performed in order to ascertain the identity (one or more characteristics) and position of respective ones of the one or more defects upon the surface. The first data can then communicated to the controller 202, storage medium (e.g. NAS server) and utilized as further discussed herein. Display of the first data (and indeed the scan data discussed subsequently) can occur in “real time”, near “real time” (within a delay of less than 4 seconds) or can be retrieved for review from the storage medium.

The defect identification system 108 can also include the one or more tracking cameras 214 which can be coupled to the tracking server (component of the processing assembly 208). These one or more tracking cameras 214 (and/or the one or more high speed cameras 216) can cooperatively provide positional information to the tracking server about the location or position of the object to be inspected as that object moves due to the movement of the conveyor or movement assembly. The one or more tracking cameras 214 and/or high speed cameras 216 can supplement or replace the encoder. The one or more tracking cameras 214 and/or high speed cameras 216 can be coupled to the triggering board and the processing assembly 208 (such as the tracking server) The one or more tracking cameras 214 can collect object positional information along the path or direction to the triggering board and such information may be used in solely or in combination with the positional information from the encoder. The one or more high speed cameras 216 can gather “stereo information” such as vibration information using at least two cameras. The one or more high speed cameras 216 can be used to determine the orientation of the object within the carrier and such orientation information as desired.

While the defect identification system 108 can be highly effective in identifying defects or potential defects, the defect identification system 108 can be a complex system with many components. The defect identification system 108 is not typically suitable for use in the vicinity of the robotic repair apparatus 110 due to the possibility of obstruction, vibration, or other interference, and also because a significant amount of space may be required for the robotic repair apparatus 110. As discussed previously in FIG. 1, typical practice is for the vehicle (the object) to be transported to a location separate from the defect identification system 108 for the robotic repair apparatus 110 to be performed.

Moreover, in some configurations, a single defect identification system 108 may be used to supply defect information for use in more than one downstream robotic repair apparatus 110.

The robotic repair apparatus 110 as previously discussed can be used for sanding and polishing one or more defects on a surface in accordance with examples herein. The robotic repair apparatus 110 can have the one or more cameras 124 (previously discussed), which may be used to locate paint/clearcoat/mat or other defects to be repaired. The robotic repair apparatus 110 includes a moving mechanism 302, which may be used to move an end-of-arm assembly 118 (FIG. 1) into proximity of a defect repair area. The robotic repair apparatus 110 can include one or more sensor(s) 304 such as a force sensor or other sensor(s) and/or actuator(s) described herein. The robotic repair apparatus 110 can include a dedicated controller, which controls movement and sensing of the arm 114 and related components. However, it is expressly contemplated that, in some embodiments, the arm 114 and / or components mounted thereon can have their own controllers or can be controlled by controller 202. The dedicated controller can receive and execute movement and sensing commands such as from controller 202.

The end-of-arm assembly 118 has been previously discussed and can include a variety of tools, as illustrated in previous FIG. 1A, for example. However, it is expressly contemplated, as illustrated in FIG. 2, that, in other embodiments, some components may be located elsewhere (not on the assembly 118) but rather coupled to the arm 114.

The first tool 120 can be mounted on the arm 114. The first tool 120, in some embodiments, is coupled to a first end effector 306. In some examples, a second tool 122 can be mounted to arm 114. The second tool 122, if used, may be coupled to a second end effector 308. A fluid removal tool 310 may be mounted to the arm 114. However, it is expressly contemplated that, in some examples, some of these components may not be one or may be on a separate arm from the arm 114. For example, the arm 114 could support the first tool 120, e.g., a sanding tool, and a second arm could support the one or more cameras 124, a second tool 122 and/or other components.

In one example, the arm 114 is moved into place by arm movement mechanism 312. The first and second tools 120, 122, one or more cameras 124 and fluid removal tool 310 may also be moved into place by arm movement mechanism 312, in one embodiment, or may each have their own movement mechanism that moves them into position on or adjacent the surface. The robotic repair apparatus 110 can have a force control unit 314. This force control unit 314 may also be located on the arm 114 to control interactions between the arm 114, end effector systems, and a workpiece surface. In some examples, an air line 316 and a fluid dispenser 318 can feed from arm 114 to the assembly 118 (FIG. 1A) to provide necessary air and fluid supply as may be necessary for operating the first tool 120 and/or the second tool 122. A fluid removal tool 310 can also coupled to the force control unit 314. The fluid removal tool 310 may be, for example, a fabric-based wiping medium, an air knife, a vacuum system, or another suitable tool. However, it is also contemplated that, in some embodiments, the fluid removal tool 310 and be coupled to a separate force control unit than that used for the first and second tool 120, 122. It is also contemplated that, in other embodiments, the fluid removal tool 310 could be a passive tool with no associated force control unit. In some example, the fluid removal tool 310 may be moved through space using a mechanism that will control variables such as the pitch, tilt, and yaw of an active wiping motion of the fluid removal tool 310.

The force control unit 314 may maintain proper force or pressure between the first tool 120, the second tool 122, and/or the fluid removal tool 310 and the surface of the object. The fluid removal tool 310 may function in conjunction with a fluid removal mechanism 322, in some examples. The fluid removal mechanism 322 may be a pad, vacuum, brush, or scraping tool used to remove particulate matter, debris, liquid or slurry from the wiping medium of the fluid removal tool 310. The fluid removal mechanism 322 may help to provide a suitably absorbent and effective wiping medium for cleaning the workpiece surface more than once.

The controller 202 can be in electronic communication with the camera (the one or more cameras 124) and the robotic paint repair apparatus 110. The controller 202 can be configured to control the one or more cameras 124 to scan an area of the surface (a portion of the entire exposed surface) based upon the first data (discussed above determined and provided by the defect identification system 108). The scan of the area by the one or more cameras 124 can collect and provide scan data representing a location and/or other information relating to one or more defects on the surface of the object at the repair location. In contrast, the first data represents information gathered by the defect identification system 108 at a location that differs from the repair location where the robotic repair apparatus 110 operates and the one or more cameras 124 are located. The controller 202 is configured to manipulate the robotic arm (arm 114) to position the tool (either the first tool 120 or the second tool 122) based upon at least the scan data gathered by the one or more cameras 124 at the repair location.

The controller 202 can be a digital controller, having one or more processors, can be software implemented or a can be implemented by a combination of software and hardware. The controller 202 can have various functions and capability such as those of the processing assembly 208 described previously. Various other functions are contemplated including as an interface between the defect identification system 108 and the robotic repair apparatus 110. The controller 202 can have various functions. These functions can be implemented in hardware, software, firmware, or any combination thereof, located locally or remotely. If implemented in software, the functions can be stored on or transmitted over a computer-readable medium as one or more instructions or code and executed by a hardware-based processing unit. Computer-readable media can include computer-readable storage media, which corresponds to a tangible medium such as data storage media, or communication media including any medium that facilitates transfer of a computer program from one place to another, e.g., according to a communication protocol. In this manner, computer-readable media generally can correspond to (1) tangible computer-readable storage media which is non-transitory or (2) a communication medium such as a signal or carrier wave. Data storage media can be any available media that can be accessed by one or more computers or one or more processors to retrieve instructions, code and/or data structures for implementation of the techniques described in this disclosure. A computer program product can include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions can be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein can refer to any of the foregoing structures or any other structure suitable for implementation of the techniques described herein. In addition, in some aspects, the functionality described herein can be provided within dedicated hardware and/or software modules. Also, the techniques could be fully implemented in one or more circuits or logic elements.

The techniques of this disclosure can be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units can be combined in a hardware unit or provided by a collection of interoperative hardware units, including one or more processors as described above, in conjunction with suitable software and/or firmware.

The functions, techniques or algorithms described herein may be implemented in software in one example. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the examples described are merely examples. The software may be executed on a digital signal processor, ASIC, microprocessor, or other type of processor operating on a computer system, such as a personal computer, server or other computer system, turning such computer system into a specifically programmed machine.

FIG. 3 shows a global coordinate system 400 for an object 101 (here the painted vehicle 102 having surface 103) to be inspected as the object 101 is transported along a repeatable object travel path or direction. The object travel path or direction can be defined in a three dimensional world coordinate system having a world origin point and a world coordinate axis. As discussed previously, the painted vehicle 102 can be mounted to the carriage 104, which can be coupled to the rail system 106 (only partially shown in FIG. 3). The travel path of the painted vehicle 102 can be the path followed by the painted vehicle 102 along the rail system 106. The world or global coordinate system shown in FIG. 3 may be defined by a point on the floor in the geometrical center of the rail system 106 (upon which the carriage 104 and painted vehicle 102 resides), with the “z” axis pointing up from the floor, the “y” axis pointing to the side of the conveyor, and the “x” axis pointing in the opposite direction of the conveyor's forward motion direction as shown in FIG. 3. FIG. 3 merely provides an example of one coordinate system with one origin that can be utilized. The surface 103 can have one or more defects 105 as shown in FIG. 3. The coordinate system of FIG. 3 can be implemented by the controller 202 and/or the processing assembly 208 of FIG. 2 to understand the position of the one or more defects 105 with respect to the global coordinate system 400. This position information can be captured as the first data discussed above in reference to FIG. 2.

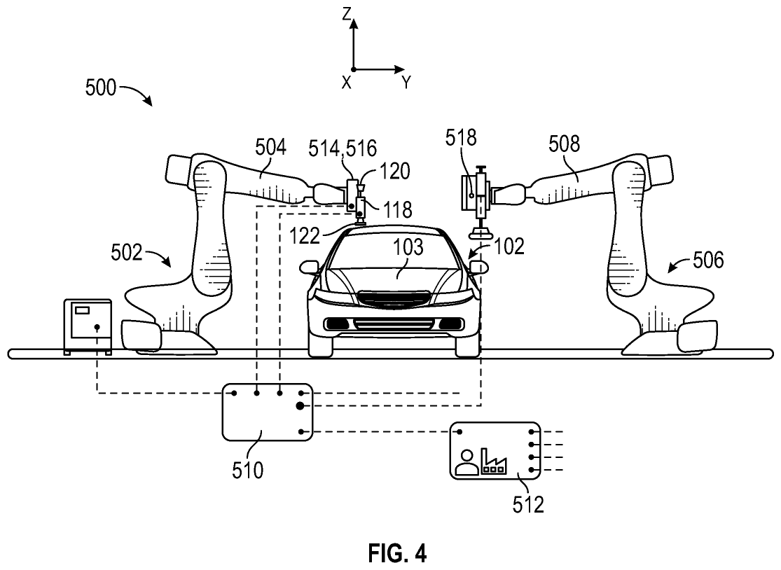

FIG. 4 is a schematic of a robotic paint inspection and repair system 500 according to one example. Many aspects of the robotic paint inspection and repair system 500 have already been previously discussed with respect to FIGS. 1 and 2. The robotic paint inspection and repair system 500 can include a robotic repair unit 502 including a robotic arm 504 and a robotic inspection unit 506 (a second robot) including a robotic arm 508. The systems may be controlled by a motion controller, which may receive instructions from one or more application controllers 510 (e.g., the controller 202). The application controller 510 may receive input, or provide output, to a user interface 512 in addition to or alternative to the controller 202 (FIG. 2).

The robotic repair unit 502 includes a force control unit 514 and end effector 516 that can be aligned with an assembly 118 as previously described. The robotic inspection unit 506 can include various components including one or more cameras 518 mounted on the robotic arm 508. The one or more cameras can have a construction similar to those of the one or more cameras 124 described previously. As illustrated in FIG. 4, the force control unit 514 can be coupled via the end effector 516 to the assembly 118. Assembly 118 can carry the first tool 120 and optionally the second tool 122 as previously discussed. The first and second tools 120, 122 can be constructed in the manner previously discussed. The one or more cameras 518 of the robotic inspection unit can implement a visual inspection on the surface 103 of the painted vehicle 102. If one or more defects are detected, these can then be repaired by the robotic repair unit 502.

The robotic paint inspection and repair system 500 can differ from those of previous systems or apparatuses in that the one or more cameras 518 can be implemented on a separate robot assembly from the robotic repair apparatus. However, inspection is implemented in the defect repair location 128 as with the embodiment of FIG. 1 discussed previously. Put another way, although the one or more cameras 518 are not directly mounted to the robotic repair unit 502, the one or more cameras 518 are in close proximity thereto when the robotic repair unit 502 performs polishing, sanding, etc.

The robotic repair unit 502 and robotic inspection unit 506 may have a base fixed to a rail system configured to travel along with a vehicle being repaired. However, arms 504 and 508 and other components can be moveable as discussed previously. Depending on a defect location, robotic repair unit 502 and robotic inspection unit 506 may need to move closer, or further away from a vehicle, or may need to move higher or lower with respect to the vehicle. FIG. 4 shows a Cartesian coordinate system illustrated for reference with x-axis, y-axis and z-axis. This coordinate system is shared with the global coordinate system 400 of FIG. 3. It is recognized that according to some examples the robotic inspection unit 506 may not be offset across the vehicle in the y-axis direction from the robotic repair unit. Rather, the robotic inspection unit 506 can be placed in another location such as on the same side of the vehicle as the robotic repair unit 502 and offset in the x-axis direction, for example. The position of the tools first and second tools 120, 122 can be varied by manipulation as previously described.

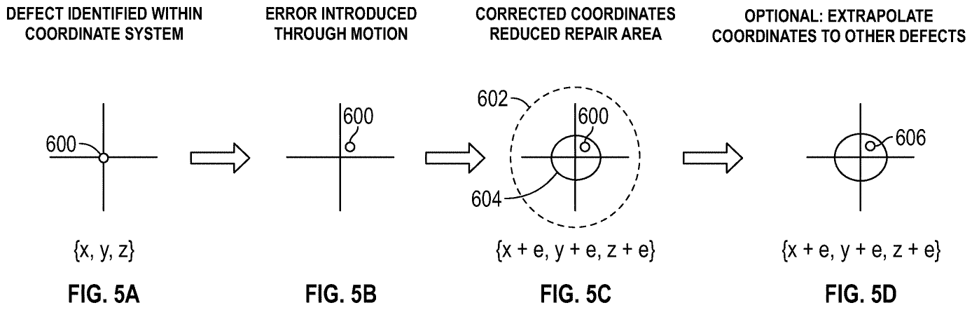

FIGS. 5A and 5B show a schematic diagram of a method whereby positional error in locating a defect is introduced through motion of an object the defect is on from a first location to a second location and a surface modification in a repair area to address the defect. FIG. 5C shows a method whereby an area that is subject to surface modification to remove the one or more defects can be reduced in size with use of the one or more cameras 124 on the arm 114 (FIG. 1) or the robotic inspection unit 506 with the one or more cameras 518 (FIG. 3) at the defect repair location.

In particular, FIG. 5A initially shows a defect 600 located within a Cartesian coordinate system using the global coordinate system 400 as determined by the defect identification system 108 (FIGS. 1-3). This defect 600 would have the coordinates shown when located at the defect detection area by the defect identification system 108. Use of a robot for defect repair requires highly precise positional information concerning the position of the identified defect on the surface of the object. This positional information can be captured as part of the first data discussed above. However, as manufacture typically requires assembly lines and movement of the object from one fabrication step to another, the object may become positionally shifted as a result of the movement. As an example, the object (vehicle) may have shifted on the carriage in one or more of the x-direction, y-direction and/or z-direction (and/or rotated about one or more of the x, y, or z axes) as it travelled along the path indicated by arrow A in FIG. 1 from the defection scanning location to the defect repair location. Alternatively, the rail system or other transport mechanism may shift in one or more of the z-direction, x-direction or y-direction (and/or rotate about one or more of the z, x or y axes) (refer to FIG. 1) as it moves from the defect scanning location to the defect repair location. Thus, although the position of the defect 600 may have been correctly positionally ascertained at FIG. 5A at the defect scanning location, the position may have shifted to a new location as shown in FIG. 5B as result of error introduced during movement from the defect scanning location to the defect repair location. Put another way, positional error may be introduced by the movement of the defect 600 from the position of FIG. 5A to that of FIG. 5B.

It should also be noted that, in some systems, the carriage (and therefore the object) continues to be in motion even as the repair process is occurring. In other words, the object is moving in the repair location while the surface repair is taking place. This means that additional positional error may continue to be introduced even after the object arrives at the repair location. Systems, apparatus, and methods according to the present disclosure can account for these continuing positional errors because new data is being collected directly at the point of repair.

Typically (in previous systems), to account for any position shift (positional error) of FIG. 5B that may have been introduced, a relatively larger area 602 or portion of the surface would be subject to surface modification. This relatively larger area 602 would ensure the defect 600 was addressed even if its position was different from what had been recorded in the first data. This relatively larger area 602 of surface modification would result in increased tool wear, material use, machining time, and reduced aesthetics as compared with surface modification of area 604. Additionally, the larger area 602 could preclude effective repair should the defect(s) occur in a challenging area. Area 604 for the surface modification is relatively smaller than the area 602. Where defect(s) occur near a challenging area such as edges, feature lines etc. a smaller repair area (area 604) may allow for a defect repair closer to those areas.

The area 604 can be achieved by using the one or more cameras 124 on the arm 114 (FIG. 1) or the robotic inspection unit 506 with the one or more cameras 518 (FIG. 3) at the defect repair location to capture and provide scan data (or second data) about an updated position of the defect 600 that results from the movement to the defect repair location.

A controller (such as controller 202) can be configured to use the first data and the scan data in various ways. For example, the controller can be configured to perform a comparison of the scan data with the first data. Based upon the comparison of the scan data with the first data, the controller can update the first data with a position of the one or more defects from the scan data (reflecting the updated position of FIG. 5B).

FIG. 5D shows further determinations by the controller including extrapolating or updating the position of at least another defect 606. In particular, based upon the updates to the first data, the controller can be configured to redetermine a position of each (or a subset) of the one or more defects (captured in the first data) on an entirety (or a portion) of the surface of the object including those of the one or more defects that are on a second portion of the surface outside the scan area of the camera. For example, the controller may determine that the entire object has shifted and/or rotated in a particular manner, such that the shift and/or rotation can be relatively predicted or determined for the global set of defects initially identified. Based upon the position of each of the one or more defects on an entirety of the surface of the object that are redetermined by the controller, the controller can be configured to manipulate the robotic arm to position the tool to perform the surface modification to those of the one or more defects on the second portion of the surface outside of the scan by the camera. Put another way, it is contemplated that the camera(s) do not have to collect scan data regarding every defect on the object prior to surface modification being performed.

In addition to gathering and redetermining just position data, the controller (such as controller 202) can be configured to gather one or more characteristics regarding the defect 600 in the scan data. Thus, the scan data need not only represent positional information but also characteristics such as a size (depth, length, width), shape (projection, depression, concave/convex), nature (color, hair, sand, dust) and/or confirm existence (i.e., ascertain that the defect 600 actually exists and is not a false positive from the first data). Thus, based upon the comparison of the scan data with the first data, the controller can update or augment the first data to reflect the one or more characteristics of the one or more defects from the scan data. Because it is possible to collect a detailed set of information relating to defects (including improved location data) directly at the point of repair, it is envisioned that in some embodiments less upfront precision may be required when collecting the first data as compared to systems where the first data is the only data available for defect location and characterization. In such embodiments, a smaller, less expensive, and or less sophisticated system may be advantageously employed for collecting the first data.

The controller can also be configured to perform various analytics on the data by comparison of the scan data to the first data. Such analytics could indicate relative positional movement has increased possibly resulting from a loosening of a carriage on the rail system. Such analytics could indicate inaccuracy in the first data as could result from one of the cameras of the defect identification system 108 being mispositioned (possibly due to being bumped, misaligned or jostled). The controller can issue an alert to personnel indicating that accuracy of the first data has decreased and/or simply that personnel should check carriage mounting, camera positioning, or other criteria of the system, for example.

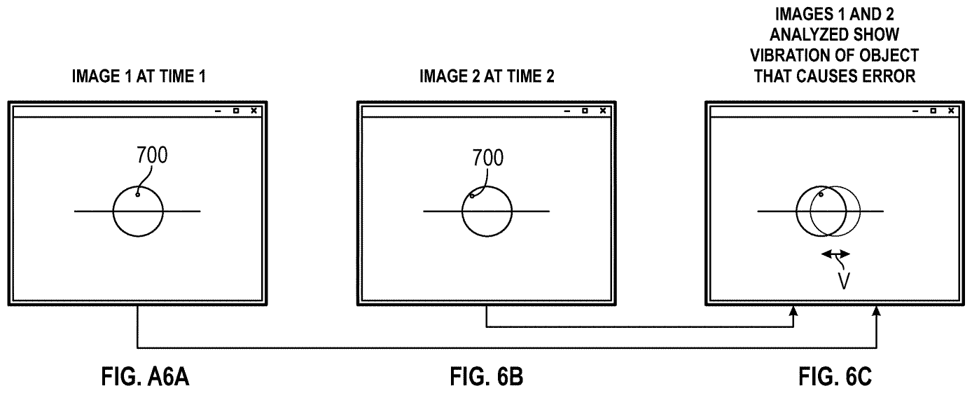

FIGS. 6A-6C illustrate that positional error may not be introduced only by movement of the object from a first location (FIG. 5A) to a second location (FIG. 5B).

Additionally, positional error can be introduced by vibration of object that results from movement of the object at the repair location. FIG. 6C contemplates that vibration can be measured locally at the defect repair location. In particular, the scan data based upon a plurality of images taken at intervals over a duration of time. Thus, a first image at first time one can be taken as shown in FIG. 6A. A second image at a second time can be taken as shown in FIG. 6B. The defect 700 in FIGS. 6A and 6B has shifted position as a result of vibration of the object at the defect repair location as indicated in FIG. 6C. High speed camera(s) capturing multiple frames per second can be utilized to capture the vibration dynamics of the object. The controller can be configured to determine a shift (indicated by arrow V in FIG. 6C) in a position of the defect 700 that results from the vibration of the object. This information can be utilized to improve positioning of the tool(s) of the robotic repair apparatus and can also be used to optimize other criteria such as engagement force of the tool, modification of force to accommodate movement, change in repair area (understanding direction and amplitude of the vibration can allow for scaling the size of the repair), change in repair tool speed, decision to skip repair at that time if motion will interfere with repair when performing the surface modification to remove the defect 700. Information about the defect type (e.g., dirt/crater/micropop/orange peel, etc.) can be better estimated from the second scan because the robot may potentially capture a higher resolution image of the defect than was acquired in the first scan. It can also obtain better information about the true size of the defect, because the original scan estimate of defect size, height, and depth may be subject to shadows. Shadows are better controlled by the moving robot arm. This information will help the robot perform a better repair and to avoid doing things like trying to repair a dent that may have been misclassified as a dirt by the prior system.

Having better quality defect data from the second scan taken by the robot also improves the quality of data sent to the factory data analytics systems, which are used to drive continuous improvement of the paint process. As an example, first defect detection system may have false positive classifications, reporting that there is a 10% chance of a defect being in a location, for example. The second scan helps avoid attempting a repair in areas where the first detection confidence was low.

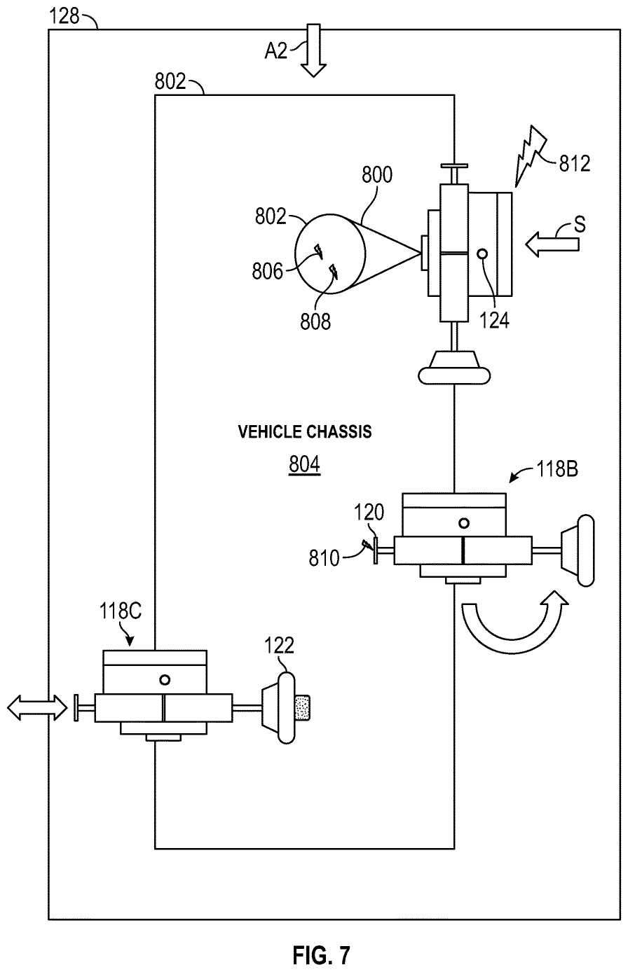

FIG. 7 shows multiple robotically mounted and manipulated assemblies 118A, 118B and 118C identical to the assembly 118 previously discussed in FIGS. 1 and 1A.

FIG. 7 illustrates some further aspects contemplated in the disclosure that are worth noting. First, the one or more cameras 124 of the assembly 118A is illustrated performing a scan 800 or a portion 802 of a surface 804 of the vehicle 102 within the defect repair location 128. This portion 802 (corresponding to a scan area) can include at least a first defect 806 and a second defect 808. The relative positions of the first defect 806 and the second defect 808 can be used for global positional realignment in the manner previously discussed in FIG. 5D such that other defects such as defect 810 can be addressed without need for scanning by the one or more cameras 124 of the second assembly 118B in some cases. Assembly 118B shows the first tool 120 performing surface modification such as sanding to remove the defect 810. Assembly 118C shows a surface modification such as polishing being performed.

FIG. 7 shows the scan data 812 is collected and transmitted while the vehicle 102 is in motion along the assembly line as indicated by arrow A2. The assemblies 118A, 118B, 118C can be manipulated by robots in tandem to address the defects 806, 808, 810, etc. in various manners. The assembly 118A is shown in the process of being zoomed in by movement of the one or more cameras 124 toward the surface 804 via manipulation of the robotic arm as indicated by arrow S to gather different data regarding the first defect 806 and the second defect 808.

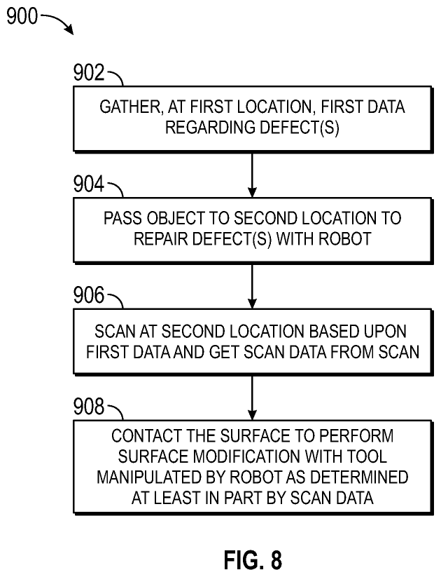

FIG. 8 shows a method 900 of identifying and repairing one or more defects on a surface of an object. The method 900 can include gathering 902, at a first location, first data representing a position of the one or more defects on the surface of the object. This can be at the location of the defect identification system 108 (FIGS. 1 and 2) as previously discussed. The method 900 can include passing 904 the object from the first location to a second location where the repairing of the one or more defects is performed by a robotic paint repair apparatus having a robotic arm and a tool mounted to the robotic arm. The method 900 can include scanning 906, at the second location, a portion of the surface of the object based upon the first data. The method 900 can include contacting 908 the surface to perform a surface modification of the object to remove the one or more defects with the tool, wherein the location of the contacting the surface is determined at least in part by the scanning, at the second location, the portion of the surface of the object.

The method 900 can optionally include other steps including determining from the first data at least a position of the one or more defects on substantially an entirety of the surface of the object. The method 900 can optionally include comparing the scan data with the first data, updating the first data with a position of the one or more defects from the scan data and redetermining a position of each of the one or more defects on an entirety of the surface of the object. The contacting the surface to perform the surface modification occurs at a second portion of the surface outside a purview of the scanning of the portion of the surface of the object. The updating the first data can include updating the first data to reflect one or more characteristics of the one or more defects from the scan data. The scanning at the second location can include moving the camera toward the object with the robotic arm to change a size of the scan area and the scan data collected. Scanning, at the second location, the portion of the surface can include taking a plurality of images at intervals over a duration of time. The method 900 optionally can include determining a shift in a position of the one or more defects that results from a vibration of the object. The method 900 can optionally include determining a shift in position of the one or more defects that results from passing the object from the first location to the second location in addition to the determining the shift in the position of the one or more defects that results from the vibration of the object.

The disclosure herein includes but is not limited to the following illustrative Examples:
Example 1 is a system for identifying and repairing one or more defects on a surface of an object, the system can include any one or combination of: a robotic paint repair apparatus, a camera and a controller. The robotic paint repair apparatus can have a robotic arm and a tool mounted to the robotic arm. The tool can be configured to contact the surface to perform a surface modification of the object to remove the one or more defects. The camera can be positioned adjacent the robotic paint repair apparatus within a repair area, the camera configured to scan a portion of the surface of the object having at least one of the one or more defects and collect scan data. The controller can be in communication with the camera and the robotic paint repair apparatus. The controller can be configured to control the camera to scan the area of the surface based upon a first data representing a location of the one or more defects on the surface of the object gathered at a location that differs from the repair area. The controller can be configured to manipulate the robotic arm to position the tool based upon at least the scan data.
Example 2 is the system of Example 1, wherein the camera can be one of mounted to a second robot or mounted to the robotic paint repair apparatus.
Example 3 is the system of any one or combination of Examples 1-2, wherein the controller can be configured to control the one of the second robot or the robotic paint repair apparatus to move to adjust a position of the camera relative to the object.
Example 4 is the system of any one or combination of Examples 1-3, wherein the controller can be configured to perform a comparison of the scan data with the first data.
Example 5 is the system of any one or combination of Examples 1-4, wherein, based upon the comparison of the scan data with the first data, the controller can update the first data with a position of the one or more defects from the scan data.
Example 6 is the system of any one or combination of Examples 1-5, wherein based upon the updates to the first data, the controller can be configured to redetermine a position of each of the one or more defects on a portion of the surface of the object including less than an entirety of the surface of the object including those of the one or more defects that are on a second portion of the surface outside the scan of the camera.
Example 7 is the system of any one or combination of Examples 1-6, wherein based upon the updates to the first data, the controller can be configured to redetermine a position of each of the one or more defects on an entirety of the surface of the object including those of the one or more defects that are on a second portion of the surface outside the scan of the camera.
Example 8 is the system of any one or combination of Examples 1-7, wherein based upon the position of each of the one or more defects on an entirety of the surface of the object redetermined by the controller, the controller is configured to manipulate the robotic arm to position the tool to perform the surface modification to those of the one or more defects on the second portion of the surface outside of the scan by the camera.
Example 9 is the system of any one or combination of Examples 1-7, wherein based upon the comparison of the scan data with the first data the controller updates the first data to reflect one or more characteristics of the one or more defects from the scan data.
Example 10 is the system of any one or combination of Examples 1-9, wherein based upon the comparison of the scan data with the first data the controller issues an alert.
Example 11 is the system of any one or combination of Examples 1-10, wherein the scan data is based upon a plurality images taken at intervals over a duration of time, and wherein based upon the scan data, the controller is configured to determine a shift in a position of the one or more defects that results from a vibration of the object.
Example 12 is the system of any one or combination of Examples 1-11, wherein the object includes a vehicle and the surface includes a specular surface, and wherein the first data is collected at the location prior to a movement of the vehicle along an assembly line to the repair area.
Example 13 is the system of any one or combination of Examples 1-12, wherein the vehicle is in motion along the assembly line during the repair and the first data and the scan data are collected while the vehicle is in motion along the assembly line.
Example 14 is a method of identifying and repairing one or more defects on a surface of an object. The method can include any one or combination of: gathering, at a first location, first data representing a position of the one or more defects on the surface of the object; passing the object from the first location to a second location where the repairing of the one or more defects is performed by a robotic paint repair apparatus having a robotic arm and a tool mounted to the robotic arm; scanning, at the second location, a portion of the surface of the object based upon the first data; and contacting the surface to perform a surface modification of the object to remove the one or more defects with the tool, wherein the location of the contacting the surface is determined at least in part by the scanning, at the second location, the portion of the surface of the object.
Example 15 is the method of any of Example 14, further optionally including:
   comparing the scan data with the first data; updating the first data with a position of the one or more defects from the scan data; and redetermining a position of each of the one or more defects on an entirety of the surface of the object.
Example 16 is the method of any one or combination of Examples 14-15, wherein the contacting the surface to perform the surface modification occurs at a second portion of the surface outside a purview of the scanning of the portion of the surface of the object.
Example 17 is the method of any one or combination of Examples 14-16, further optionally including: comparing the scan data with the first data; updating the first data to reflect one or more characteristics of the one or more defects from the scan data.
Example 18 is the method of any one or combination of Examples 14-17, wherein scanning, at the second location, the portion of the surface includes moving a camera toward or away from the object with the robotic arm.
Example 19 is the method of any one or combination of Examples 14-18, wherein scanning, at the second location, the portion of the surface includes taking a plurality of images at intervals over a duration of time, and further including determining a shift in a position of the one or more defects that results from a vibration of the object.
Example 20 is the method of any one or combination of Examples 14-19, further including determining a shift in position of the one or more defects that results from passing the object from the first location to the second location in addition to the determining the shift in the position of the one or more defects that results from the vibration of the object.
Example 21 is the method of any one or combination of Examples 14-20, further including moving the vehicle along an assembly line while contacting the surface to perform the surface modification of the object to remove the one or more defects with the tool.
Example 22 is the method of any one or combination of Examples 14-21, further including moving the vehicle along an assembly line while gathering, at the first location, the first data representing the position of the one or more defects on the surface of the object and scanning, at the second location, the portion of the surface of the object based upon the first data.
Example 23 is a method of identifying and repairing one or more defects on a surface of an object, the method optionally including any one or combination of: scanning, at a first location, to gather first scan data; determining from the first scan data at least a position of the one or more defects on substantially an entirety of the surface of the object; passing the object from the first location to a second location where the repairing of the one or more defects is performed by a robotic paint repair apparatus having a robotic arm and a tool mounted to the robotic arm; scanning, at the second location, only a portion of the surface of the object to gather second scan data, wherein the portion of the surface selected for the scanning is based upon the first scan data; comparing the first scan data to the second scan data; based upon the comparing, updating at least the position of the one or more defects to reflect a shift in the position of the one or more defects; and contacting the surface to perform a surface modification of the object to remove the one or more defects with the tool, wherein the location of the contacting the surface is determined based upon the shift in the position of the defects.
Example 24 is the method of Example 23, wherein updating the position of the one or more defects to reflect the shift in the position of the one or more defects includes redetermining the position of each of the one or more defects on the entirety of the surface of the object.
Example 25 is the method of any one or combination of Examples 23-24, wherein the contacting the surface to perform the surface modification occurs at a second portion of the surface outside a purview of the scanning of the portion of the surface of the object.
Example 26 is the method of any one or combination of Examples 23-25, further including updating the first scan data to reflect one or more characteristics of the one or more defects from the second scan data.
Example 27 is the method of any one or combination of Examples 23-26, wherein scanning, at the second location, only the portion of the surface includes moving a camera toward or away from the object with the robotic arm.
Example 28 is the method of any one or combination of Examples 23-27, wherein scanning, at the second location, only the portion of the surface includes taking a plurality of images at intervals over a duration of time, and further including determining the shift in the position of the one or more defects that results from a vibration of the object.
Example 29 is the method of any one or combination of Examples 23-28, further including moving the vehicle along an assembly line while contacting the surface to perform the surface modification of the object to remove the one or more defects with the tool.
Example 30 is the method of any one or combination of Examples 23-29, further including moving the vehicle along an assembly line while scanning, at the first location, to gather the first scan data and scanning, at the second location, only the portion of the surface of the object to gather the second scan data.

The various examples 1-30 described above can be combined in any combination. Elements thereof can be combined in any combination. The elements thereof are optional unless otherwise indicated.

Various examples have been described. These and other examples are within the scope of the following claims.

1. A system for identifying and repairing one or more defects on a surface of an object, the system comprising:
a robotic paint repair apparatus having a robotic arm and a tool mounted to the robotic arm, wherein the tool is configured to contact the surface to perform a surface modification of the object to remove the one or more defects;
a camera positioned adjacent the robotic paint repair apparatus within a repair area, the camera configured to scan a portion of the surface of the object having at least one of the one or more defects and collect scan data; and
a controller in communication with the camera and the robotic paint repair apparatus, the controller configured to control the camera to scan the area of the surface based upon a first data representing a location of the one or more defects on the surface of the object gathered at a location that differs from the repair area, wherein the controller is configured to manipulate the robotic arm to position the tool based upon at least the scan data.

2. The system of claim 1, wherein the camera is one of mounted to a second robot or mounted to the robotic paint repair apparatus.

3. The system of claim 2, wherein the controller is configured to control the one of the second robot or the robotic paint repair apparatus to move to adjust a position of the camera relative to the object.

4. The system of claim 1, wherein the controller is configured to perform a comparison of the scan data with the first data.

5. The system of claim 4, wherein, based upon the comparison of the scan data with the first data, the controller updates the first data with a position of the one or more defects from the scan data.

6. The system of claim 5, wherein based upon the updates to the first data, the controller is configured to redetermine a position of each of the one or more defects on a portion of the surface of the object comprising less than an entirety of the surface of the object including those of the one or more defects that are on a second portion of the surface outside the scan of the camera.

7. The system of claim 5, wherein based upon the updates to the first data, the controller is configured to redetermine a position of each of the one or more defects on an entirety of the surface of the object including those of the one or more defects that are on a second portion of the surface outside the scan of the camera.

8. The system of claim 7, wherein based upon the position of each of the one or more defects on an entirety of the surface of the object redetermined by the controller, the controller is configured to manipulate the robotic arm to position the tool to perform the surface modification to those of the one or more defects on the second portion of the surface outside of the scan by the camera.

9. The system of claim 4, wherein based upon the comparison of the scan data with the first data the controller updates the first data to reflect one or more characteristics of the one or more defects from the scan data.

10. The system of claim 4, wherein based upon the comparison of the scan data with the first data the controller issues an alert.

11. The system of claim 1, wherein the scan data is based upon a plurality images taken at intervals over a duration of time, and wherein based upon the scan data, the controller is configured to determine a shift in a position of the one or more defects that results from a vibration of the object.

12. The system of claim 1, wherein the object comprises a vehicle and the surface comprises a specular surface, and wherein the first data is collected at the location prior to a movement of the vehicle along an assembly line to the repair area.

13. The system of claim 11, wherein the vehicle is in motion along the assembly line during the repair and the first data and the scan data are collected while the vehicle is in motion along the assembly line.

14. A method of identifying and repairing one or more defects on a surface of an object, the method comprising:
gathering, at a first location, first data representing a position of the one or more defects on the surface of the object;
passing the object from the first location to a second location where the repairing of the one or more defects is performed by a robotic paint repair apparatus having a robotic arm and a tool mounted to the robotic arm;
scanning, at the second location, a portion of the surface of the object based upon the first data; and
contacting the surface to perform a surface modification of the object to remove the one or more defects with the tool, wherein the location of the contacting the surface is determined at least in part by the scanning, at the second location, the portion of the surface of the object.

15. The method of claim 14, further comprising:
comparing the scan data with the first data;
updating the first data with a position of the one or more defects from the scan data; and
redetermining a position of each of the one or more defects on an entirety of the surface of the object, wherein the contacting the surface to perform the surface modification occurs at a second portion of the surface outside a purview of the scanning of the portion of the surface of the object.

16. (canceled)

17. The method of claim 14, further comprising:
comparing the scan data with the first data;
updating the first data to reflect one or more characteristics of the one or more defects from the scan data.

18. The method of claim 14, wherein scanning, at the second location, the portion of the surface includes moving a camera toward or away from the object with the robotic arm.

19. The method of claim 14, wherein scanning, at the second location, the portion of the surface includes taking a plurality of images at intervals over a duration of time, and further comprising determining a shift in a position of the one or more defects that results from a vibration of the object.

20. The method of claim 19, further comprising determining a shift in position of the one or more defects that results from passing the object from the first location to the second location in addition to the determining the shift in the position of the one or more defects that results from the vibration of the object.

21. The method of claim 14, further comprising moving the vehicle along an assembly line while contacting the surface to perform the surface modification of the object to remove the one or more defects with the tool, further comprising moving the vehicle along an assembly line while gathering, at the first location, the first data representing the position of the one or more defects on the surface of the object and scanning, at the second location, the portion of the surface of the object based upon the first data.

22.-30. (canceled)
